(19) United States
(12) Patent Application Publication
(10) Pub. No.: US 2011/0098399 A1
(43) Pub. Date: Apr. 28, 2011

(54) Cutting Filament for a Trimmer and Method of Producing Such a Cutting Filament

(75) Inventor: Roland Schierling, Affalterbach (DE)

(73) Assignee: Andreas Stihl AG & Co KG, Waiblingen (DE)

(21) Appl. No.: 12/859,190

(22) Filed: Aug. 18, 2010

(30) Foreign Application Priority Data
Oct. 24, 2009 (DE) 10 2009 050 593.8

(51) Int. Cl. C08K 3/36; C08L 77/00; D01D 5/00

(52) U.S. Cl. 524/493; 524/606; 264/210.8

(57) ABSTRACT

A cutting filament for a manually-guided trimmer, and a method of producing such a filament. A polymeric material is filled with platelet-shaped particles. The filled polymeric material is extruded in the form of a filament blank. In the solidified state, the filament blank is spun in the direction of its longitudinal axis, accompanied by plastic deformation, in such a way that the embedded particles are oriented at least predominantly in the direction of the longitudinal axis.

The instant application should be granted the priority date of Oct. 24, 2009, the filing date of the corresponding German patent application 10 2009 050 593.8.

### BACKGROUND OF THE INVENTION

The present invention relates to a cutting filament for a manually-guided trimmer, as well as to a method of producing such a cutting filament.

A rapidly rotating cutting head having a cutting filament is used with manually-guided, motor-driven trimmers. As a consequence of the effective centrifugal forces, the cutting filament orients itself radially relative to the axis of rotation, and cuts off grass or other plant parts. The chief stress on the cutting filament results from radially acting centrifugal forces, which act upon the filament material in the axial direction thereof.

So that under the stress of operation the cutting filament does not stretch too much or even tear, an extruded filament of polymeric material is produced as a blank, which subsequent to the extrusion process is spun accompanied by plastic deformation. During the spinning, the polymeric chain molecules orient themselves in the longitudinal direction. Under high spinning conditions, high longitudinal rigidity and strength are achieved, which reduces stretching and the tendency to tear.

However, there is further stress upon the cutting filament, namely wear, which results from the contact of the cutting filament with the material that is to be cut, or with harder objects such as rocks or the like. A splitting-apart of the cutting filament is observed in particular as evidence of damage. The splitting apart can be traced back to insufficient strength transverse to the longitudinal direction of the filament. The chain molecules, which as a result of the spinning are oriented in the longitudinal direction, have the drawback that the transverse strength within the cutting filament is reduced, thus favoring the tendency to split apart.

It is an object of the present invention to improve a cutting filament of the aforementioned general type in such a way that its resistance to wear is increased.

It is a further object of the present invention to provide a method of producing such a cutting filament, by means of which the cutting filament obtains an increased resistance to wear.

### BRIEF DESCRIPTION OF THE DRAWINGS

These and other objects and advantages of the present invention will appear more clearly from the following specification in conjunction with the accompanying schematic drawings, in which:

FIG. 1 is an overall view of a manually-guided trimmer having an inventively embodied cutting filament;

FIG. 2 is a side view showing a portion of an extruded filament blank of polymeric material that is filled with nanoparticles;

FIG. 3: shows the filament blank of FIG. 2 spun to form the inventive cutting filament;

FIG. 4: is a cross-sectional illustration of the cutting filament of FIG. 3;

FIG. 5: is an enlarged illustration of the detail V of FIG. 2 with platelet-shaped nanoparticles embedded in the polymeric material in an unoriented fashion in the extruded state;

FIG. 6: is an enlarged illustration of the detail VI of FIG. 3 with nanoparticles oriented in the direction of the longitudinal axis; and

FIG. 7: is an enlarged illustration of the detail VII in FIG. 4 showing particulars of the spatial orientation of the platelet-shaped nanoparticles in the cross-section of the cutting filament.

### SUMMARY OF THE INVENTION

The cutting filament of the present application is formed of a polymeric material that is filled with platelet-shaped particles and that has been spun such that the platelet-shaped particles are oriented at least predominantly in the direction of the longitudinal axis of the cutting filament.

The method of the present application of producing such a cutting filament includes the steps of filling a polymeric material with platelet-shaped particles, extruding the filled polymeric material to form a filament blank, and spinning the filament blank, in a solidified state thereof, in the direction of the longitudinal axis of the blank, accompanied by plastic deformation, such that the platelet-shaped particles embedded in the polymeric material orient themselves at least predominantly in the direction of the longitudinal axis of the blank.

With the inventive cutting filament, and also with the associated production method, a polymeric material having a filling of small plates or platelet-shaped particles is used. From this polymeric material that is filled with platelet-shaped particles, a filament blank is extruded and is subsequently, in the solidified state, spun in the direction of its longitudinal axis, accompanied by plastic deformation, in such a way that the embedded particles are oriented at least predominantly in the direction of the longitudinal axis. In so doing, a cutting filament results within which the platelet-shaped and essentially planar particles are respectively disposed in a plane that is oriented parallel to the longitudinal axis of the cutting filament.

The aforementioned orientation of the particles as a consequence of the spinning process leads to a defined reinforcement of the polymeric material in the longitudinal direction of the cutting filament, and also transverse thereto. This is based upon the recognition that the platelet-shaped particles in the polymeric material display a direction-dependent reinforcing effect that manifests itself essentially only in the plane of the individual flat or laminar particles. With an unoriented arrangement of the laminar particles, a considerable proportion thereof are disposed transverse to the longitudinal axis of the cutting element and cannot act in the direction of the longitudinal axis of the cutting filament, in other words, in the direction of the centrifugal force stress. It is even possible that they can reduce the load-carrying capacity of the filled polymeric material. However, due to the spinning process of the present application, the initially randomly spatially distributed particles, including those that in an undesired manner are disposed transverse to the longitudinal axis of the cutting filament, are reoriented and together with the polymeric chain molecules are oriented in the axial direction of the cutting filament. On the one hand, in so doing the cutting filament is reinforced in its axial direction by means of the laminar particles, whereby this reinforcement acts upon the polymeric chain molecules, which are oriented in the axial direction by means of the spinning process, in a reinforcing manner. In the longitudinal, i.e. axial, direction, the cutting filament obtains an increased rigidity and also strength. However, since the laminar, platelet-shaped particles at the same time are provided with an elongation in the radial or tangential direction relative to the longitudinal axis of the cutting filament, they eliminate the drawback of the tendency to split apart that is observed with the prior art filaments. A splitting open or splitting apart of the filament cross-section is reliably avoided by means of the cohesion or holding force of the particles, which also acts in the transverse direction. The resistance of the inventive cutting filament to wear is significantly improved.

The platelet-shaped particles are expediently embodied as nanoparticles, and preferably have a magnitude in their plane of 500 nm to 1000 nm, and a thickness of 0.5 nm to 2 nm. They are advantageously formed by a layered or stratified silicate. The percentage by weight of the particles in the cutting filament is expediently in a range of from and including 1% to and including 5%, and preferably in a range of from and including 2% to and including 3%. Polyamide has been shown to be expedient as the polymeric material in which the particles are embedded.

Further specific features of the present invention will be described in detail subsequently.

### DESCRIPTION OF SPECIFIC EMBODIMENTS

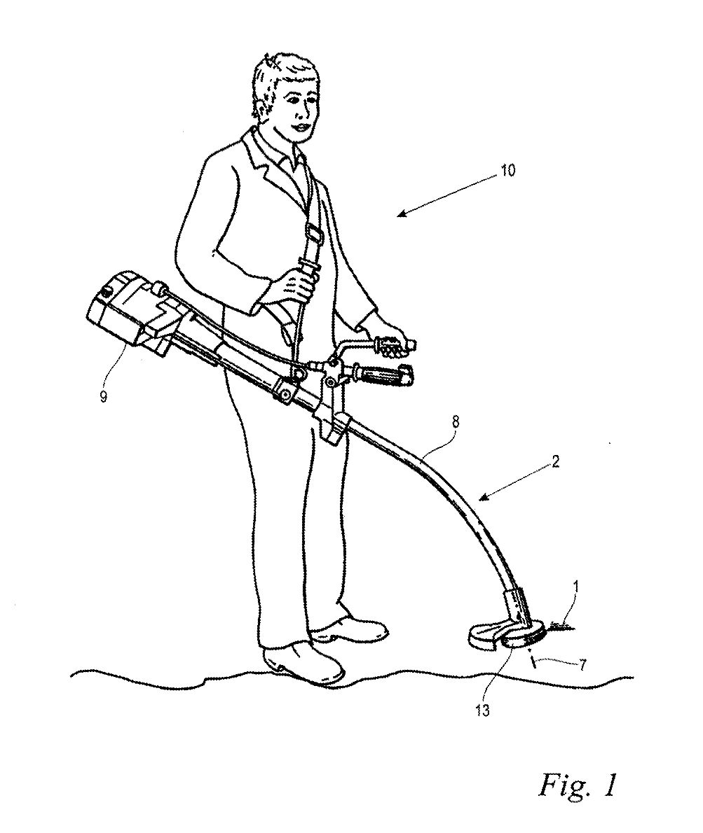

Referring now to the drawings in detail, the overall view of FIG. 1 shows a trimmer 2, which is carried by an operator 10 and is manually guided. The trimmer 2 includes a drive motor 9, which can be an electric motor or an internal combustion engine, and which is disposed at that end of a guide tube 8 that is closer to the operator. Disposed at the opposite end of the guide tube 8 is a cutting head 13, which is rotatably mounted and has a cutting filament 1 that extends radially therefrom. By means of a non-illustrated drive shaft mounted in the guide tube 8, the cutting head 13, together with the cutting filament 1, is rotatably driven about an axis of rotation 7 by means of the drive motor 9. The centrifugal forces that as a result act upon the cutting filament 1 orient it in the radial direction. The operator 10 guides the cutting head 13, together with the cutting filament 1, in such a way on a surface that is to be worked that the radially oriented cutting filament 1, as a consequence of its rotational movement, makes contact with the material that is to be cut, such as grass or the like, thereby cutting or mowing down the grass or other plants. As a result of the effective centrifugal forces, the cutting filament 1 is subjected to stress in its longitudinal axis, which is disposed radially relative to the axis of rotation 7. In addition, the cutting filament can split apart transverse thereto.

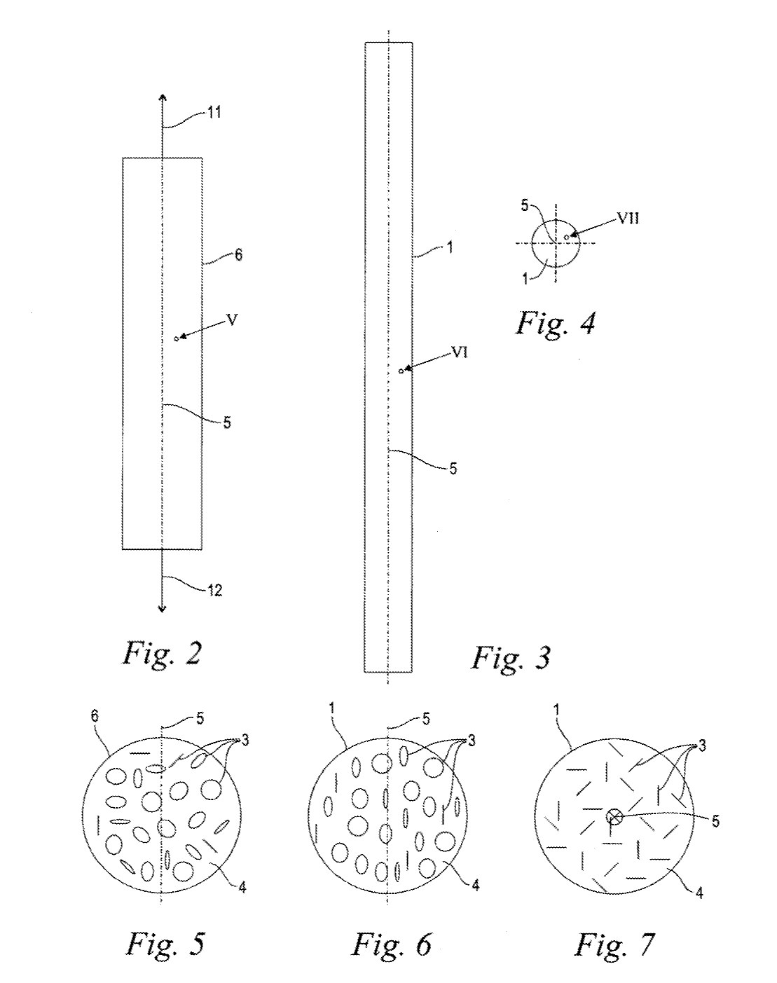

The schematic side view of FIG. 2 shows a portion of a filament blank 6, which extends along a longitudinal axis 5. A detail from FIG. 2, which is designated by the symbol V, is shown in an enlarged detailed illustration in FIG. 5, according to which the filament blank 6 is formed of a polymeric material 4 in which is embedded a plurality of particles 3. The particles 3 are in the form of flat, small plates that here, for the sake of illustration, are schematically illustrated as circular disks. In practice, the particles have an irregular shape. However, in any case they have an at least approximately planar, flat shape, whereby the dimensions of the particles in their planes have a magnitude that is in the micrometer or smaller range. The particles 3 are preferably embodied as nanoparticles having a maximum dimension in the sub-micrometer range, namely in the nanometer range, whereby the dimensions of the particles 3 in their planes have a magnitude of approximately 500 nm to approximately 1000 nm. In comparison thereto, the thickness of the particles 3 is several orders of magnitude smaller, lying in a range of from 0.5 nm to 2 nm, and in the illustrated embodiment being approximately 1 nm. The percent by weight of the particles 3 in the filament blank 6, and also in the cutting filament 1 later produced therefrom (FIGS. 1, 3), is advantageously in a range of from and including 1% to and including 5%, and in particular in a range of from and including 2% to and including 3%. Polyamide is selected as the material for the polymeric material 4.

A layered or stratified silicate is selected for the material of the particles 3. In the illustrated embodiment, this silicate is formed of bentonite, which is cleaved or split up into individual small plates or platelets of the aforementioned size by phase separation, intercalation, and subsequent exfoliation. The individual platelet-shaped particles 3 are uniformly distributed in the polymeric material 4.

The filament blank 6 of FIG. 2 is extruded from the material of FIG. 5, whereby in the extruded state the particles 3 are distributed uniformly not only with regard to their location, but also with respect to their spatial orientation; in other words, the particles have no noteworthy spatial preferential orientation. It can be recognized in particular in the illustration of FIG. 5 that a considerable proportion of the platelet-shaped particles 3 are provided in planes that are disposed transverse to the longitudinal axis 5. In this way, they can exert no reinforcement effect in the direction of the longitudinal axis 5, or even display a weakening effect in this direction.

After the extrusion process of the filament blank 6, the latter, in the solidified state, is spun, accompanied by plastic deformation, in the direction of its longitudinal axis 5 by the application of a longitudinal force in conformity with the arrows 11, 12 of FIG. 3, so that the cutting filament 1 is formed, a portion of which is schematically illustrated in FIG. 3. In contrast to the filament blank 6 of FIG. 2, the cutting filament 1 of FIG. 3 is elongated, yet has a smaller cross-sectional area. A cross-sectional view of the cutting filament 1 transverse to the longitudinal axis 5 is illustrated in FIG. 4, accordingly being provided with a circular disk shaped cross-section. However, some other cross-sectional shape can also be expedient.

FIG. 6 shows an enlarged illustration of the detail VI in FIG. 3, according to which the platelet-shaped particles 3 that are embedded in the polymeric material 4 are oriented at least predominantly in the direction of the longitudinal axis 5. This orientation is brought about by the spinning of the filament blank 6 (FIG. 2) to form the cutting filament 1 (FIG. 3). During the spinning, the polymeric chain molecules of the polymeric material 4 orient themselves in the direction of the longitudinal axis 5, and in so doing at the same time bring about a reorientation of the stochastically or randomly distributed particles 3 of FIG. 5 into the state shown in FIG. 6.

FIG. 7 is an enlarged illustration of the detail VII of FIG. 4 in a cross-sectional illustration of the cutting filament 1. Here also the particles are shown in their position where they have been reoriented by the spinning process. By viewing FIGS. 6 and 7, it can be seen that each individual platelet-shaped particle 3 defines a plane that is disposed parallel to the longitudinal axis 5, and furthermore extends either radially or tangentially, i.e. in the manner of a secant, thereto. In this respective plane, the particles 3 have a reinforcing effect upon the polymeric material 4. Since all of the particles 3 are disposed at least approximately parallel to the longitudinal axis 5 (FIG. 6), the cutting filament 1 is reinforced in the direction of its longitudinal axis 5. Furthermore, by viewing both FIGS. 4 and 7, it can been that the respective planes of all of the particles 3 are disposed radially, i.e. tangentially, or in the manner of a secant, relative to the longitudinal axis 5, and hence reinforce the cross-section of the cutting filament 1. Therefore, the cross-section of the cutting filament 1 cannot, or can to only a limited degree, split open or fan out.

On the whole, the cutting filament 1 is therefore reinforced with regard to its chiefly occurring operational and wear loads in such a way that a significantly increased service life can be observed.

The specification incorporates by reference the disclosure of German priority document 10 2009 050 593.8 filed Oct. 24, 2009.

The present invention is, of course, in no way restricted to the specific disclosure of the specification and drawings, but also encompasses any modifications within the scope of the appended claims.

What I claim is:

1. A cutting filament for a manually-guided trimmer, wherein said cutting filament is formed of a polymeric material that is filled with platelet-shaped particles and that has been spun such that said platelet-shaped particles are oriented at least predominantly in the direction of a longitudinal axis of said cutting filament.

2. A cutting filament according to claim 1, wherein said platelet-shaped particles are nanoparticles.

3. A cutting filament according to claim 2, wherein a plane of said nanoparticles has a magnitude of from 500 nm to 1000 nm, and a thickness of from 0.5 nm to 2 nm.

4. A cutting filament according to claim 1, wherein said platelet-shaped particles are formed by a layered or stratified silicate.

5. A cutting filament according to claim 1, wherein a percentage by weight of said platelet-shaped particles in said cutting filament is in a range of from and including 1% to and including 5%.

6. A cutting filament according to claim 5, wherein said percentage by weight of said platelet-shaped particles in said cutting filament is in a range of from and including 2% to and including 3%.

7. A cutting filament according to claim 1, wherein said polymeric material is polyamide.

8. A method of producing a cutting filament for a manually-guided trimmer, including the steps of:
filling a polymeric material with platelet-shaped particles;
extruding said polymeric material to form a filament blank; and
spinning said filament blank, in a solidified state thereof, in the direction of a longitudinal axis of said filament blank, accompanied by plastic deformation, such that said platelet-shaped particles embedded in said polymeric material orient themselves at least predominantly in the direction of said longitudinal axis.
